(19) United States
(12) Patent Application Publication
(10) Pub. No.: US 2024/0053000 A1
(43) Pub. Date: Feb. 15, 2024

(54) NIGHT LIFE EMERGENCY PACK

(71) Applicants: Karen L. Gayton, Gainesville, GA (US); William E. Gayton, Gainesville, GA (US); Jacob H. Gayton, Gainesville, GA (US)

(72) Inventors: Karen L. Gayton, Gainesville, GA (US); William E. Gayton, Gainesville, GA (US); Jacob H. Gayton, Gainesville, GA (US)

(21) Appl. No.: 18/487,207

(22) Filed: Oct. 16, 2023

Related U.S. Application Data
(63) Continuation-in-part of application No. 17/367,241, filed on Jul. 2, 2021, now Pat. No. 11,786,801.
(60) Provisional application No. 63/047,911, filed on Jul. 2, 2020.

(51) Int. Cl. F21V 33/00; F21S 9/03; F21V 23/04

(52) U.S. Cl. CPC F21V 33/0076; F21S 9/03; F21V 23/0442; F21Y 2115/10

(57) ABSTRACT

A safety/emergency pack/kit having a water-resistant, light-colored or transparent case with a reversibly closeable opening, a light, which can be seen through the case and serviced or replaced through the reversibly closeable opening. The case operating to protect the light from water and other elements due to its being water-resistant. Also included is a device to connect or attach the pack/kit to a surface, so that surface can display one or more light signals from the pack/kit for safety and/or in emergency situations. There are many different types of devices which can be used to connect or attach the pack/kit to a surface, examples include, but are not limited to, various types of adhesives, straps, ropes, snaps, fasteners, hook and loop fasteners, etc.

### REFERENCE TO RELATED APPLICATIONS

This application is both a Divisional and a Continuation in Part of U.S. application Ser. No. 17/367,241, filed Jul. 2, 2021, entitled NIGHT LIFE GEAR. Additionally, this application claims priority to, and incorporates in reference by its entirety, U.S. application Ser. No. 17/367,241, filed Jul. 2, 2021, entitled NIGHT LIFE GEAR, and U.S. Provisional Application No. 63/047,911, filed Jul. 2, 2020, entitled NIGHT LIFE SAFETY GEAR.

### BACKGROUND OF THE INVENTION

The present invention involves increasing fun and safety during activities at night or at other times when light is scarce or visibility is otherwise decreased.

### SUMMARY OF THE INVENTION

The present invention seeks to provide a solution by employing light up and/or glowing devices for any or all items used at night or at times of low visibility. This will allow for people, pets, other animals, and others sought to be protected (like androids, robots, other expensive equipment etc.) to easily be spotted at night to avoid getting hurt or damaged due to being unseen.

In one embodiment, A safety pack/kit, comprises at least one water-resistant case, the at least one case being light-colored or transparent and having an opening which is reversibly closeable to maintain the water-resistant property of the at least one case (the cases can come in a selectable, pre-determined choice of case size); at least one light, the at least one light being placed in the opening of the at least one case, whereby the at least one case protects the at least one light from water, due to the at least one case being water-resistant, while permitting the at least one light to be visible and exhibit at least one safety signal, due to the at least one case being light-colored or transparent, (the light or lights can be clear or colored or a combination of the two),
the at least one light being serviced or replaced via the opening in the at least one case; and
at least one adhesive, e.g., tape, the at least one adhesive being used to attach the at least one case to a surface.

In another embodiment of the safety kit, the at least one light is at least two lights and the at least one safety signal exhibited by the at least two lights is red lights, steady lights, blinking lights, multi-colored lights, color-changing lights, chasing lights or neon-colored lights.

In another embodiment of the safety kit, the colored lights are LED lights.

In another embodiment, the safety kit further comprises an alarm safety signal.

In another embodiment, the safety kit further comprises at least one sensor to activate the at least one safety signal.

In another embodiment, the safety kit further comprises at least one power source which is chargeable, re-chargeable, solar or battery.

In another embodiment, the safety kit further comprises at least one button on the power source to activate the at least one safety signal.

In another embodiment, the safety kit further comprises turn signals.

In another embodiment, the safety kit further comprises at least one other safety signal in the form of a distress signal.

In another embodiment of the safety kit, the distress signal comprises three short flashes of light, three long flashes of light and then three short flashes of light, which is an SOS (Save Our Ship) signal.

In another embodiment of the safety kit, the at least one safety signal exhibited by the at least one light is a colored light; it can be any color or a combination of colors.

In another embodiment of the safety kit, the power source is USB type A, B or C.

In another embodiment, the safety kit further comprises a kinetic or motion sensor, whereby movement of the safety kit is detected and a safety signal is exhibited in response to movement of the safety kit.

In another embodiment, the safety kit further comprises an impact activated sensor, whereby the impact activated sensor senses an impact to the surface on which the safety kit is attached and a safety signal is exhibited in response to sensing an impact to the surface on which the safety kit is attached.

In another embodiment, the safety kit further comprises a photo-sensitive light activated sensor (activated by available ambient light) having at least one photo-sensitive light being activated thereby, whereby the at least one photo-sensitive light is lit or powered on when it is dark (it usually activates when it starts to get darker, when there is less light available).

In another embodiment, the safety kit further comprises speakers or at least one horn for exhibiting an audible safety signal.

In another embodiment of the safety kit, the safety pack is an emergency pack for use during emergencies.

Another embodiment of the invention is an emergency kit which comprises at least one water-resistant case, the at least one case being light-colored or transparent and having an opening which is reversibly closeable to maintain the water-resistant property of the at least one case (the cases can come in a selectable, pre-determined choice of case size);
an LED light having a customizable size to fit in the at least one case (e.g., the fit can be customized by the light being cut, squashed or folded to fit into the case); the LED light being placed in the opening of the at least one case, whereby the at least one case protects the LED light from water, due to the at least one case being water-resistant, while permitting the at least one LED light to be visible and exhibit at least one safety signal, due to the at least one case being light-colored or transparent,
the at least one LED light being serviced or replaced via the opening in the at least one case; and at least one connecting device to connect the case to a surface, the connecting device can be a strap, like a belt, or it can be elastic, or adhesive, or a strap with hook and loop closures, e.g., Velcro®; additionally, the case can have attachment points for the connecting device, e.g., loops, pockets, straps, etc. to better secure the connecting device to the case and, ultimately to the surface. The connecting device can be at least one adhesive strip to attach the at least one case to a surface. The connecting device can be a double-sided adhesive, so that it adheres to both the case and the surface, additionally zip lock-groove-type and hook and loop type closures can be used as double-sided connecting devices.

In another embodiment of the emergency kit, the LED light is in the form of a tube, string or rope.

In another embodiment of the emergency kit, the LED light is customizable by cutting the tube, string or rope and sealing it in the at least one case, or by folding the tube, string or rope.

In another embodiment of the emergency kit, the LED light is comprised of red lights, steady lights, blinking lights, multi-colored lights, color-changing lights, chasing lights or neon-colored lights.

In another embodiment of the emergency kit, the connecting device is at least one strap or an adhesive strip.

In another embodiment of the emergency kit, at least one of the at least one cases further comprises attachment loops for securing the connecting device to at least one of the at least one cases, whereby the connecting device connects the at least one of the at least one cases to the surface.

### FIELD OF THE INVENTION

The invention is in the newly invented field of safety packs/kits to increase safety during activities at night or at other times when light is scarce or visibility is otherwise decreased.

### BRIEF DESCRIPTION OF THE FIGURES

FIG. 1 depicts an example of a case or pocket for holding the at least one light, lighting system and/or glowing device so that it can be kept water-resistant/waterproof and still be serviced or replaced;

FIG. 2 depicts another example of a case for holding the at least one light, lighting system and/or glowing device so that it can be kept water-resistant/waterproof and still be serviced or replaced;

FIG. 3 depicts some examples of devices that can be used to control a lighting system and/or locator device in accordance with one embodiment of the invention;

FIG. 4 depicts an example of attached or attachable light/lights, GPS and/or other locator device, alarm, health sensor and/or any other type of sensor; and

FIG. 5 depicts an example of a case or pocket with an example of attached or attachable light/lights, GPS and/or other locator device, alarm, health sensor and/or any other type of sensor, as well as examples of power source and solar charger.

### DETAILED DESCRIPTION OF THE INVENTION

The following definitions are used for the terms described herein:

### Definitions

Case refers to a three-dimensional container or enclosure designed to hold and transport items in three spatial dimensions, which means it has length, width, and height.
Gear refers to clothing, equipment or other accessories needed or used for something specific.
Light or lights refer to one or more devices that light up, one or more lights, lighting systems and/or glow devices.

Components and functions of exemplary devices will now be described with reference to the drawings. The following detailed description includes specific details in order to provide an understanding of examples of the invention. Reference is made to the accompanying drawings which form a part hereof, and in which is shown by way of illustration specific embodiments in which the invention and its components may be implemented. These embodiments are described in sufficient detail to enable those skilled in the art to practice the novel products and methods, and it is to be understood that other embodiments may be utilized and that changes may be made without departing from the spirit and scope of the teachings herein. The following detailed description is, therefore, not to be taken in a limiting sense. Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

### COMPONENTS IN THE FIGURES

Lights 12
Switch/button and/or operating system 14
Phone 16
Watch 18
Computer, method or other smart device 20
Attachable light/lights, locator device, health sensor and/or any other type of sensor 22
Power source 24
Solar charger 26
Surfboard 28
Button/switch/Bluetooth/smart sensor 30
Locator and/or sensor 32
Groove/recess 46
Case or pocket 48
Case or pocket flap 50
Tape 52
Case or pocket 54
Fastener 56
Case or pocket 58
Folding indicators 60, 61
Fastening strips 62, 63

These cases/pockets 54 and 58 can be made of a waterproof or water-resistant material which can be transparent or somewhat transparent and/or have a light color to allow light(s) and/or lighting system and/or glowing device 12 to shine through the material.

In accordance with the present invention, the case has a width, length and height suitable for holding/carrying the light(s). For example, a width of about ¼ inch to about 12 inches, about 1 inch to about 10 inches, about 2 inches to about 6 inches, and anything in between; a length of about % inch to about 36 inches, about 1 inch to about 30 inches, about 2 inches to about 24 inches, about 6 inches to about 18 inches, and anything in between; and a height of about % inch to about 24 inches, about 1 inch to about 18 inches, about 2 inches to about 12 inches, about 3 inches to about 6 inches, and anything in between. These length, width and height dimensions are exemplary in nature to demonstrate the three-dimensional aspect of the case and its suitability to holding/carrying a variety of light(s) and amounts of lights on surfaces of different sizes. The actual dimensions of the length, width and height of the case of the present invention can vary from the examples identified. One of more of the cases of the invention can be attached to unlimited types of surfaces for safety, including emergency situations, by way of non-limiting example, any of the gear described herein, or the case(s) can be attached to a person, pet, animal, robot, android, or something they wear, or to a buoy, piece of equipment, etc.

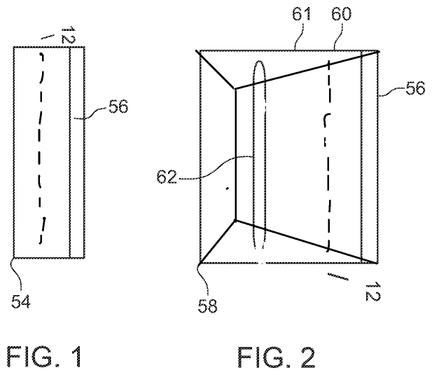

FIG. 1 includes an example of case 54, which can be a waterproof/water resistant case. Case 54 can include fastener 56, which can be a permanent fastener, e.g., glue, heat sealed section, tape, etc., or a reversible fastener such as zipper or Ziploc® type reversible zipper or hook and loop fasteners, such as Velcro®, etc. The at least one light or lighting system 12 is shown inside case 54.

FIG. 2 includes an example of case 58 for holding the at least one light or lighting system 12, which can be serviced or replaced. Case 58 can be a waterproof/water resistant case. Additionally, case 58 can include fastener 56, which can be a permanent fastener, e.g., glue, heat sealed section, tape, etc., or a reversible fastener such as zipper or Ziploc® type reversible zipper or hook and loop fasteners, such as Velcro®, etc.

The water tightness of the fastener 56 can be improved by folding it over on top of case 58 using folding indicators 60, 61. When fastener 56 is folded over at folding indicator 60 towards fastener strip 62, one can view another fastener strip 63 (not shown, but same or similar to fastener strip 62 and fastening to fastener strip 62), which is located on the reverse side of the case 58 shown in FIG. 12. Then, when case 58 together with fastener 56 and fastener strip 63 is folded over at folding indicator 61 towards fastener strip 62, then fastener strip 62 can be fastened to fastener strip 63. Fastener strips 62, 63 are re-fastenable fastening devices such as a zipper or Ziploc® type reversible zipper or hook and loop fasteners, such as Velcro®, snaps, releasable double-sided tape, and other re-fastenable fastening devices now known or to be invented, so that the opening in case 58 at fastener 56 is better protected from water entering therein and damaging the at least one light or lighting system 12.

Fastener strips 62 and 63 can be in the form of a single fastening strip, as shown or can be in the form of several strips (in the shape of a strip or other shapes, e.g., circles, ovals, squares, etc.). When there is more than one fastening strip in place of single fastening strips 62, 63, they should be placed so that the fastening strips in place of single fastening strip 62 line up with the at least one fastening strip in place of single fastening strip 63, so that the folded over section can be secured. The fastener strips 62, 63 can be made using reversible fasteners so that the lights in the case or pocket can be accessed for service or replacement.

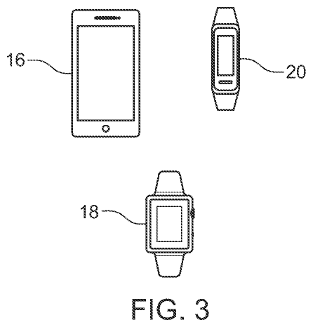

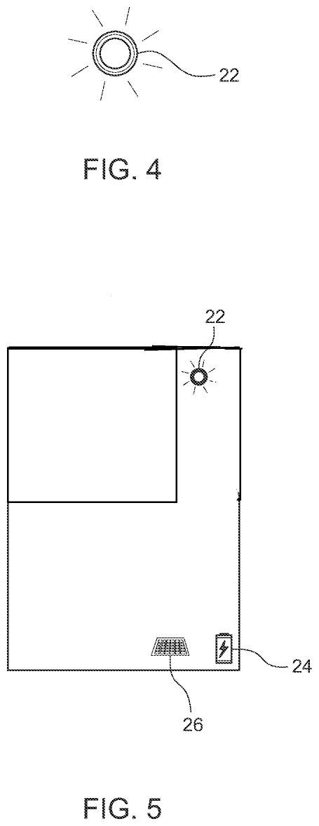

FIG. 3 displays examples of devices which can be used to operate lights, a lighting system and/or GPS and/or other locating device. These examples include, but are not limited to a phone 16, watch 18 and/or computer, method or other smart device 20. Devices such as phone 16, watch 18 and/or computer, method or other smart device 20 can also be used to receive information from an item of gear, specifically from a GPS or other locating device, health sensor and/or other type of sensor, such as that shown in FIG. 4.

FIG. 4. Includes an example of attached or attachable light/lights, GPS and/or other locator device, alarm, health sensor and/or any other type of sensor 22. An item of gear in accordance with the invention can include one or more attached or attachable light/lights, locator device, health sensor and/or any other type of sensor 22. Examples of such a locator device 22 includes GPS trackers, Tile®, and others, such as shown in U.S. Pat. No. 10,740,664, application Ser. No. 15/849,704, filed Dec. 21, 2017, issued Aug. 11, 2020, entitled WIRELESS LOW POWER FLEXIBLE AND REMOVABLY ATTACHABLE TAG AND CORRESPONDING LOCATING DEVICE, SYSTEM, AND METHOD OF USE, which is incorporated herein by reference in its entirety. These locator devices 22 can be embedded in the item of gear when the item of gear is being made or attached later in after-market sales.

FIG. 5 includes an example of a case, with an example of attached or attachable light/lights, GPS and/or other locator device, alarm, health sensor and/or any other type of sensor 22, as well as examples of power source 24 and solar charger 26. Power source 24 can be chargeable, battery operated, and/or any other source of power or means to operate the attached or attachable light/lights, GPS and/or other locator device, health sensor and/or any other type of sensor 22. The example of an item of gear, vest 10, in FIG. 5 can also include a switch/button and/or operating system 14 to control at least one light, lighting system, alarm, health sensor, other type of sensor and/or locator device, such as that shown in FIG. 2.

Any currently known gear or technology utilized in the present invention includes gear or technology currently known and/or discovered in the future.

The present invention is especially useful for any night-time or low light sports activities so that an item of gear and/or the person wearing and/or using the item of gear can be more easily found. The user can be found by being spotted by the light(s) or lighting system 12, the locators, sensors 22/32. Additionally, the user can be found by signaling others using the light(s) or lighting system 12, the locators, sensors 22/32.

The invention may or may not include one or more of the following safety items: lights, glowing devices, locator device and or capabilities, safety alarm, solar technology, solar power for powering the safety items, fiber optic thread that lights up, batteries, charging station and or chargeable capabilities, blue tooth capabilities, software, control switches and/or buttons, health detectors and/or sensors, drowning or sinking detection and/or monitoring capabilities, detection, monitoring capabilities, reflectors, touch sensors, turn signals, and/or any device, mechanism or means to make an item light-up and/or glow.

Safety items include lighting items.

Gear items include but are not limited to these items: any or all types life safety vests, floatation devices, wake surfing boards, surf boards, wake boards, water skis, snow skis, snow boards, balls, boating ropes for water sports, separating swim lanes and/or boat tie up, tubes, floats, floaties, helmets, clothing, shoes, socks, boots, equipment, paddle boards, paddles, uniforms, swim wear, clothing, pucks, clubs, watches, accessories, gloves, mats, hats, sports glasses, goggles etc.

Other lighting items may be any type of light, lights, or lighting system used, including but not limited to LED and/or fiberoptics.

These lighting items may or may not have color changing technology.

Lighting items and/or other safety items may be manufactured into, added onto, and/or attached to for use with invention items.

Examples of the attachable method can include inserting lighting and/or other safety items into other invention items and/or using waterproof adhesive, glue, tape, snaps, straps, Velcro®, buckle, or any means of attachment to attach lighting and/or other safety items to other invention items for use. a permanent fastener, e.g., glue, heat sealed section, tape,

The lighting and/or other safety items may or may not be waterproof, breathable, heat-resistant.

The lighting and/or other safety items may be battery powered, chargeable, solar powered and/or any other method to make item function as intended.

For the purposes of the present invention, lights and other items capable of lighting up and/or glowing include at least the following: LED lights, lighting strips, stick, ropes, etc., flexible LED lights and lighting strips, submersible LED lights, LED foam sticks, clip-on LED lights, battery powered lights and LED lights, re-chargeable lights and LED lights, portable lights, portable stick on lights, glow sticks or other glowing material, battery powered glow sticks/glowing material, including LEDs, rechargeable glow sticks/glowing material, including LEDs, reflectors, reflective material is also included, any of the lights can be water resistant/waterproof and/or have water resistant/waterproof (the light can be in a water resistant or waterproof case or pocket).

The lights can be white lights, colored lights, neon-colored lights, multi-colored lights, color-changing lights, single colored light, color chasing lights etc.

The case is made of materials suitably water-resistant, light-colored or transparent. Some examples include various types of plastics, treated fabrics, plant materials, etc.

The items capable of lighting up and/or glowing can be enclosed in object, fabric, etc. or covered on top, or otherwise, case/pocket can be fully enclosed case attached to gear or in the form of a covering which covers the at least one light or glowing device and is permanently or reversibly fastened to the gear by a fastening device.

Additional embodiments of the invention can include sports or recreational items made with one or more safety features to allow a person and/or item more safety protection features when participating in a sport or recreational activity. Features include one or more of the following:
Invention item can light up for night sports and/or recreational activities at night allowing person or item to be seen by others. May use any type of light, lights, or lighting system. including but not limited to: LED and/or fiberoptics.
Invention item may have chip, locator, or trackable device capabilities.
Invention item may have a safety alarm.
Invention item may have detector, sensor, monitor, and/or any other way to detect sinking, drowning, and/or health concerns such as heart rate, blood pressure and/or any other medical issue.
Invention item may have blue tooth technology.
Invention may have Software compatibility.
Invention may be accessed through it's app, phone, any smart device, and/or any other means needed to function properly.
Invention may have charging capabilities and/or charging stations.
Invention may be battery operated, chargeable, solar powered, and/or any other method to make item function as intended.
Invention may or may not have color changing and/or blinking lights.
Invention items (with one or more safety feature), include, but are not limited to: all sports items, life safety vests, floatation devices, wake surfing boards, surf boards, wake boards, water skis, snow skis, snow boards, ropes for any water sport, tow ropes, tie ropes, tubes, floats, floaties, helmets, skate boards, long boards, paddle boards, sail boats, water crafts, kayaks, jet skis, paddles, boats, balls, pucks, clubs, uniforms, swim wear, clothing, watches, accessories, gloves, shoes, boots, mats, hats, glasses, goggles, watches, wrist bands, fishing rods.
Invention item's features may by manufactured into, added onto, and or attachable. The attachable method may or may not be attached by inserting into item and/or using waterproof adhesive, glue, snaps, straps, Velcro, or any other means to be attached for use.
Invention items may or may not be waterproof, breathable, heat resistant.
Lights include fiber optics or any means to light up and/or glow.
The lights may or may not be solar powered/battery operated, or have any means to charge/power the light, including new technology, like self-charging battery operated light known as eBulb/used with or without smart device and/or tracking system, implanted or attached to the gear.

Although preferred embodiments of the present invention have been described herein it will be understood by those skilled in the art that the present invention should not be limited to the described preferred embodiments. Rather, various changes and modifications can be made within the spirit and scope of the present invention.

All of the material in these patent application documents are subject to copyright protection under the copyright laws of the United States and other countries. The copyright owner has no objection to the facsimile reproduction by anyone of the patent application documents, as it appears in official governmental records but, otherwise, all other copyright rights whatsoever are reserved.

1. A safety pack/kit, comprising:
at least one water-resistant case, the at least one case being light-colored or transparent and having an opening which is reversibly closeable to maintain the water-resistant property of the at least one case;
at least one light, the at least one light being placed in the opening of the at least one case, whereby the at least one case protects the at least one light from water, due to the at least one case being water-resistant, while permitting the at least one light to be visible and exhibit at least one safety signal, due to the at least one case being light-colored or transparent,
the at least one light being serviced or replaced via the opening in the at least one case; and
at least one adhesive, the at least one adhesive being used to attach the at least one case to a surface.

2. The safety kit of claim 1, wherein the at least one light is at least two lights and the at least one safety signal exhibited by the at least two lights is red lights, steady lights, blinking lights, multi-colored lights, color-changing lights, chasing lights or neon-colored lights.

3. The safety kit of claim 2, wherein the colored lights are LED lights.

4. The safety kit of claim 1, further comprising an alarm safety signal.

5. The safety kit of claim 1, further comprising at least one sensor to activate the at least one safety signal.

6. The safety kit of claim 1, further comprising at least one power source which is chargeable, re-chargeable, solar or battery.

7. The safety kit of claim 6, further comprising at least one button on the power source to activate the at least one safety signal.

8. The safety kit of claim 1, further comprising turn signals.

9. The safety kit of claim 1, further comprising at least one other safety signal in the form of a distress signal.

10. The safety kit of claim 9, wherein the distress signal comprises three short flashes of light, three long flashes of light and then three short flashes of light.

11. The safety kit of claim 2, wherein the at least one safety signal exhibited by the at least one light is a red colored light.

12. The safety kit of claim 6, wherein the power source is USB type A, B or C.

13. The safety kit of claim 1, further comprising a kinetic or motion sensor, whereby movement of the safety kit is detected and a safety signal is exhibited in response to movement of the safety kit.

14. The safety kit of claim 1, further comprising an impact activated sensor, whereby the impact activated sensor senses an impact to the surface on which the safety kit is attached and a safety signal is exhibited in response to sensing an impact to the surface on which the safety kit is attached.

15. The safety kit of claim 1, further comprising a photo-sensitive light activated sensor having at least one photo-sensitive light being activated thereby, whereby the at least one photo-sensitive light is lit or powered on when it is dark.

16. The safety kit of claim 1, further comprising speakers or at least one horn for exhibiting an audible safety signal.

17. The safety kit of claim 1, wherein the safety pack is an emergency pack for use during emergencies.

18. An emergency kit comprising:
at least one water-resistant case, the at least one case being light-colored or transparent and having an opening which is reversibly closeable to maintain the water-resistant property of the at least one case;
an LED light having a customizable size to fit in the at least one case; the LED light being placed in the opening of the at least one case, whereby the at least one case protects the LED light from water, due to the at least one case being water-resistant, while permitting the at least one LED light to be visible and exhibit at least one safety signal, due to the at least one case being light-colored or transparent,
the at least one LED light being serviced or replaced via the opening in the at least one case; and
at least one connecting device to connect the case to a surface.

19. The emergency kit of claim 18, wherein the LED light is in the form of a tube, string or rope.

20. The emergency kit of claim 19, wherein the LED light is customizable by cutting the tube, string or rope and sealing it in the at least one case, or by folding the tube, string or rope.

21. The emergency kit of claim 18, wherein the LED light is comprised of red lights, steady lights, blinking lights, multi-colored lights, color-changing lights, chasing lights or neon-colored lights.

22. The emergency kit of claim 18, wherein the connecting device is at least one strap or an adhesive strip.

23. The emergency kit of claim 18, wherein at least one of the at least one cases further comprises attachment loops for securing the connecting device to at least one of the at least one cases, whereby the connecting device connects the at least one of the at least one cases to the surface.
